(19) United States
(12) Patent Application Publication
(10) Pub. No.: US 2009/0304466 A1
(43) Pub. Date: Dec. 10, 2009

(54) CUTTING PLATE SECURED BY INTERLOCK ON A SUPPORT PLATE

(76) Inventors: Jörg Kabelitz, Altbach (DE); Hans-Peter Schumacher, Quierschied (DE); Manfred Kvitta, Ebersbach (DE); Ralph Kvitta, Ebersbach (DE); Otto Eder, Kongen (DE)

Correspondence Address: FULBRIGHT & JAWORSKI, LLP, 666 FIFTH AVE, NEW YORK, NY, 10103-3198, US

(21) Appl. No.: 12/159,068

(22) PCT Filed: Jan. 5, 2007
(86) PCT No.: PCT/EP2007/050110

§ 371 Date: Jul. 10, 2009

(30) Foreign Application Priority Data
Jan. 9, 2006 (DE) 102006001309.3
Nov. 7, 2006 (DE) 102006052701.1

(51) Int. Cl. B23B 27/16

(52) U.S. Cl. 407/107

(57) ABSTRACT

The invention relates to a cutting tool for machining processes, in essence composed of a clamping holder with a recess for accepting a support plate and with a cutting plate secured on the support plate by way of a clamping claw. It is proposed, for secure fastening of the cutting plate on the clamping holder, that an interlocking tongue-and-groove connection is used for positioning of the cutting plate on the support plate.

The invention relates to a cutting tool for machining processes according to the preamble of claim 1, and to a cutting plate for securing to the cutting tool.

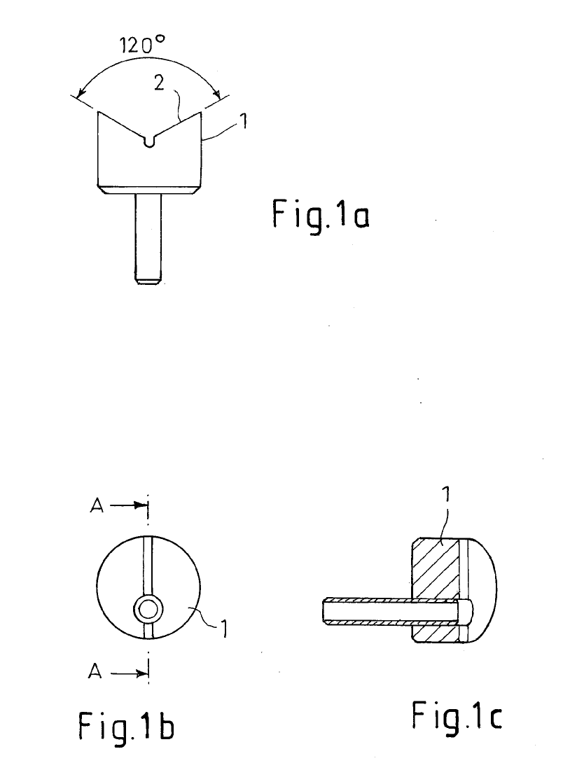

FIGS. 1a, b, c show a support plate according to the prior art, in this case for receiving circular cutting plates. For this purpose the support plate 1 is provided with a 120 degree prism 2 in which a cutting plate (not shown here) is inserted (cf. EP 0 350 938 A1).

With a cutting plate thickness of, for example, 4.76 mm, the cutting plate is very thin at the throat of the prism. In addition the tolerances of the cutting plate with respect to the support plate lead to inexact positioning. An adequate seating of the plate is therefore not ensured. At present this applies in particular to CBN cutting plates, that is, cutting plates made of cubic boron nitride.

It is the object of the invention to specify a cutting tool according to the preamble of claim 1, and an associated cutting plate in which the fastening of the cutting plate to the cutting tool is substantially improved.

According to the invention this object is achieved by the features of claims 1 and 8.

Because the cutting plate is positioned on the support plate by means of an interlocking tongue-and-groove connection, fastening is substantially improved.

In a configuration according to the invention the cutting plate has on its underside oriented towards the support plate a groove in which a feather key engages form-fittingly, which feather key is either formed integrally with the support plate or is fastened therein or thereon.

The upper side of the support plate oriented towards the cutting plate advantageously has a slot into which the feather key is inserted form-fittingly as a separate component.

The feather key is preferably made of a ceramic material.

In one configuration, the cutting plate has on its underside oriented towards the support plate a raised feather key which engages form-fittingly in a corresponding groove in the upper side of the support plate oriented towards the cutting plate.

The support plate is advantageously fastened to the clamping holder, as far as possible, by means of a screw, the support plate being pulled into its seating in the recess by tightening of the screw.

In a configuration, the support plate has on its underside oriented towards the clamping holder a tongue which engages in a corresponding groove in the clamping holder, or vice versa.

A cutting plate according to the invention for machining processes, with an upper side having a cutting edge and an underside for being supported on a cutting tool, in particular for use in the cutting tool described above, is characterised according to the invention in that the underside of the cutting plate has a groove for fastening of the cutting plate to the support by means of an interlocking tongue-and-groove connection.

The groove on the underside is advantageously formed continuously. The material of the cutting plate consists preferably of a ceramic. It may also be a cubic boron nitride (CBN) or a metal.

Through the interposition according to the invention of an interlocking tongue-and-groove connection between cutting plate and support plate, improved seating of the plate is ensured because of the flat-ground cutting plate and the guidance in the key. A further advantage lies in the fact that the support plate can be screwed from the front and the groove wedge can also be designed in a ceramic material, which results in less warping in the holder through the heat generated during machining.

The invention is described in more detail below with reference to the Figures.

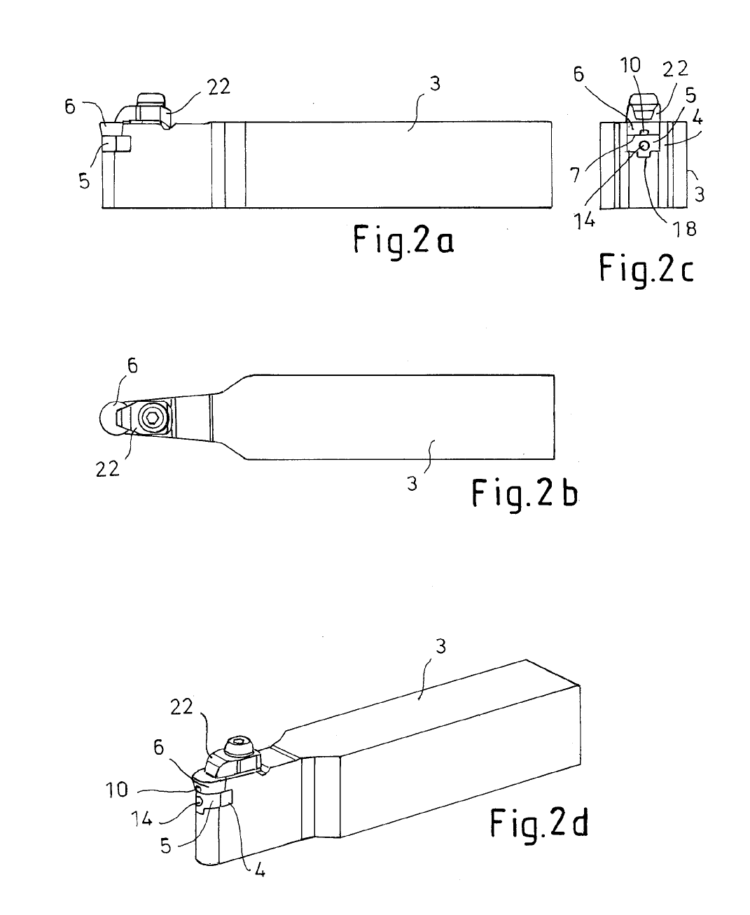

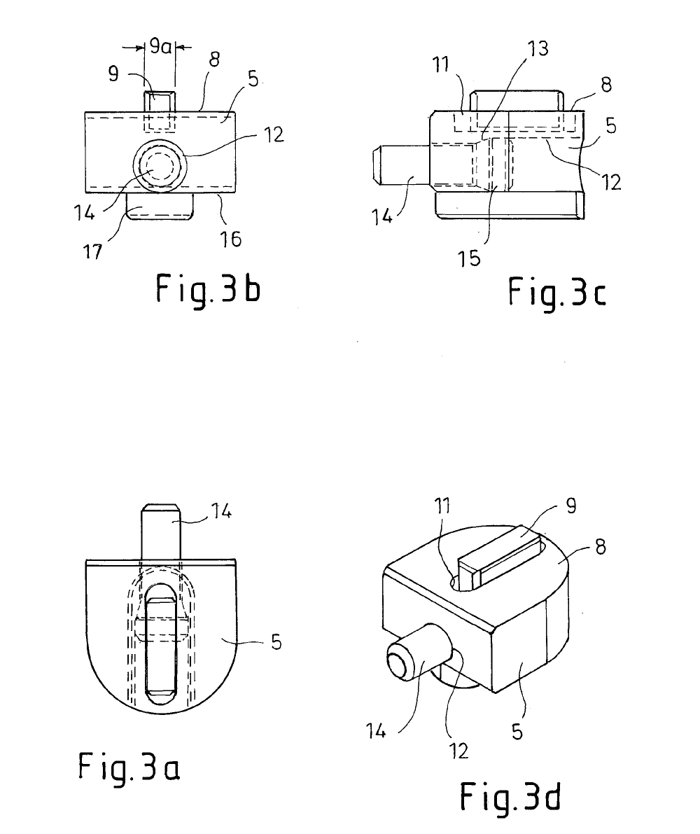

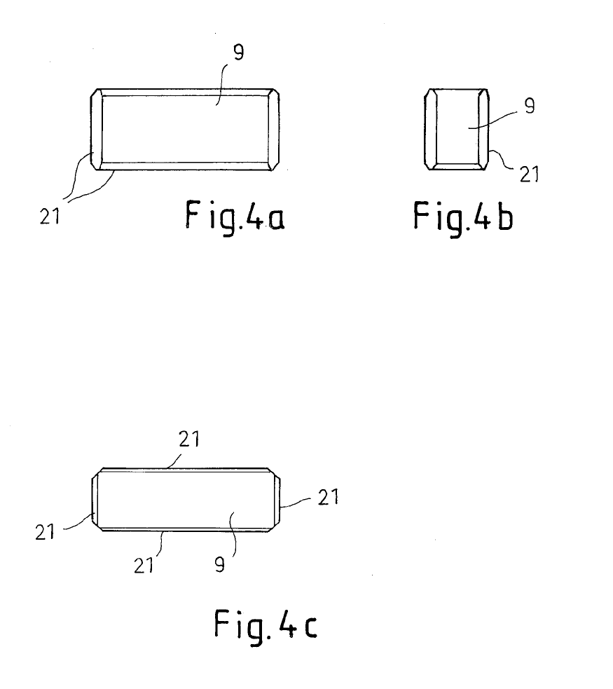

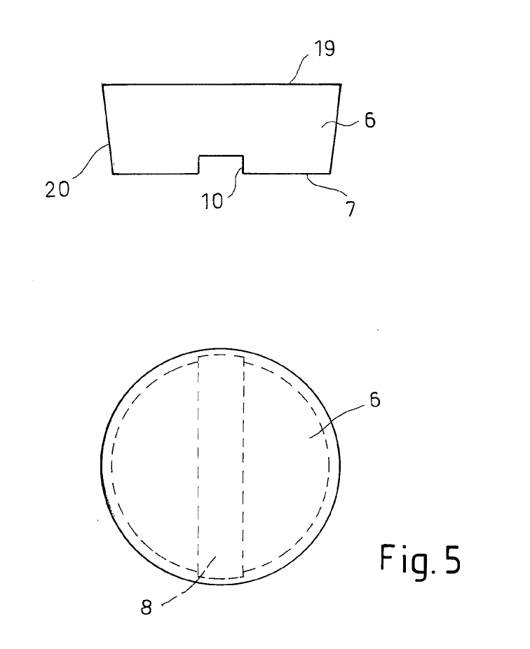

FIGS. 2a, b, c show a clamping holder 3 with a recess 4 for receiving a support plate 5. The support plate 5 is itself shown in FIGS. 3a, b, c, d. FIGS. 4a, b, c show the associated feather key 9 and FIG. 5 shows a cutting plate 6 according to the invention.

The cutting plate 6 is preferably a circular cutting plate but may also have other geometries; it has a groove 10 in its underside 7 oriented towards the support plate 5 (cf. in particular FIG. 5). The cutting plate 6 is preferably made of a ceramic material, but may also consist of another material, for example metal. The cutting plate 6 is fastened to the clamping holder 3 by means of a clamping claw 22.

A support plate 5, shown in detail in FIG. 3, is inserted in a recess 4 of the clamping holder 3. The support plate 5 has on its upper side 8 oriented towards the cutting plate 6 a feather key 9, the width 9a of which is adapted to the groove 10 in the cutting plate 6.

The feather key 9 is preferably a separate component (cf. FIG. 4) and is made of a ceramic material. In this preferred embodiment a slot 11, into which the feather key 9 is inserted, is formed in the upper side 8 of the support plate 5.

The support plate 5 is screwed to the clamping holder 3. For this purpose it has a bore 12 with a conically decreasing diameter 13. A screw 14 can be inserted in this bore 12, the head of which screw 14 bears against the conically decreasing diameter 13 and the thread of which screw 14 engages in a corresponding screw thread in the clamping holder 3. The support plate 5 is pulled into its seating in the recess 4 of the clamping holder 3 by tightening of the screw 14.

On its underside 16 oriented towards the clamping holder 3 the support plate 5 has a tongue 17 which engages in a corresponding groove 18 in the clamping holder 3. This groove 18 (cf. FIG. 2c) serves to guide the support plate 5 on the clamping holder 3.

The support [sic] plate 6 (cf. FIG. 5) is configured here as a circular cutting plate and is provided with a flat upper side 19. The groove 10 in its underside 7 is preferably formed continuously. A cubic boron nitride (CBN) is preferably suitable as the material for this cutting plate 6. However, it may consist of a different material. The flank 20 of the cutting plate 6 preferably has a conical configuration, the diameter of the cutting plate 6 decreasing in the direction towards the groove 10.

The feather key 9 (cf. FIG. 4) is provided with a chamfer 21 on each of its edges and preferably consists of a ceramic material.

1-10. (canceled)

11. A cutting tool for machining processes, comprising:
a clamping holder with a recess for receiving a support plate;
a clamping claw; and
a cutting plate which is secured to the support plate by said clamping claw,
wherein said cutting plate s positioned on said support plate by an interlocking tongue-and-groove connection.

12. A cutting tool according to claim 11, wherein the cutting plate has on an underside oriented towards said support plate a groove in which a feather key engages in a form-fitting manner, wherein said feather key is either formed integrally with the support plate or is fastened therein or thereon.

13. A cutting tool according to claim 12, wherein the upper side of the support plate oriented towards said cutting plate has a slot into which the feather key is inserted in a form-fitting manner as a separate component.

14. A cutting tool according to claim 12, wherein said feather key comprises a ceramic material.

15. A cutting tool according to claim 11, wherein said cutting plate has on an underside thereof oriented towards the support plate a raised feather key which engages in a form-fitting manner in a corresponding groove in the upper side of the support plate oriented towards the cutting plate.

16. A cutting tool according to claim 11, wherein the support plate is secured to the clamping holder by means of a screw, the support plate being pulled into its seating in the recess by tightening of the screw.

17. A cutting tool according to claim 11, wherein the support plate has on an underside thereof oriented towards the clamping holder a tongue which engages in a corresponding groove in the clamping holder or vice versa.

18. A cutting plate for machining processes, with an upper side having a cutting edge and an underside for being supported on a cutting tool, in particular for use in a cutting tool according to claim 11, wherein the underside of the cutting plate has a groove for fastening the cutting plate to the support by means of an interlocking tongue-and-groove connection.

19. A cutting plate according to claim 18, wherein the groove on the underside is formed continuously.

20. A cutting plate according to claim 18, wherein the cutting plate comprises a ceramic material or a cubic boron nitride.
